(19) United States
(12) Patent Application Publication
(10) Pub. No.: US 2022/0332611 A1
(43) Pub. Date: Oct. 20, 2022

(54) METHODS AND COMPOSITIONS FOR THE TREATMENT OF PRODUCED WATER

(71) Applicant: SOLUGEN, INC., Houston, TX (US)

(72) Inventors: Tom Swanson, Houston, TX (US); Sean Hunt, Houston, TX (US); Gaurab Chakrabarti, Houston, TX (US); Jun Su An, Houston, TX (US)

(73) Assignee: SOLUGEN, INC., Houston, TX (US)

(21) Appl. No.: 17/631,338

(22) PCT Filed: Jul. 30, 2020
(86) PCT No.: PCT/US2020/044308

§ 371 Date: Jan. 28, 2022

Related U.S. Application Data
(60) Provisional application No. 62/882,453, filed on Aug. 2, 2019.

(51) Int. Cl. C02F 1/68; C02F 1/72; E21B 21/06

(52) U.S. Cl. CPC C02F 1/683; C02F 1/722; E21B 21/068; C02F 2103/10

(57) ABSTRACT

A method of purifying a produced water comprising contacting a produced water stream with a composition comprising a (i) a chelant; (ii) an oxidizing agent; and (iii) a surfactant under conditions suitable for the formation of a purified produced water. A composition for purifying produced water comprising (i) a biochelant in an amount of from about 1 wt. % to about 10 wt. %: (ii) an oxidizing agent in an amount of from about 3 wt. % to about 50 wt. %; (iii) a surfactant in an amount of from about 0.1 wt. % to about 70 wt. % wherein the weight percentage is based on the total weight of the composition; and (iv) a solvent.

### CROSS-REFERENCE TO RELATED APPLICATIONS

The present application is claims priority to U.S. Provisional Patent Application No. 62/882,453 filed Aug. 2, 2019, and entitled “Water Treatment Formulation” which is incorporated by reference herein in its entirety.

### TECHNICAL FIELD

The present disclosure relates to compositions and methods for use in wellbore servicing. More specifically, the present disclosure relates to compositions for the treatment of produced water.

### BACKGROUND

In subsurface formations, naturally occurring rocks are generally permeated with fluids such as water, oil, or gas (or some combination of these fluids). The less dense hydrocarbons migrated to trap locations, displacing some of the water from the formation when becoming hydrocarbon reservoirs. Thus, reservoir rocks normally contain both petroleum hydrocarbons (liquid and gas) and water.

When hydrocarbons are produced, they are brought to the surface as a produced fluid mixture. The composition of this produced fluid mixture is dependent on whether crude oil or natural gas is being produced and generally includes a mixture of either liquid or gaseous hydrocarbons, produced water, dissolved or suspended solids, produced solids such as sand or silt, and injected fluids and additives that may have been placed in the formation as a result of exploration and production activities. Produced water can also be called “brine”, “saltwater”, or “formation water.”

Produced water is not a single commodity. The physical and chemical properties of produced water vary considerably depending on the geographic location of the field, the geological formation with which the produced water has been in contact for thousands of years, and the type of hydrocarbon product being produced. Produced water properties and volume can even vary throughout the lifetime of a reservoir. Characteristics of produced water include high total dissolved solids content, dissolved organic constituents such as benzene and toluene, an oil and grease component, and chemicals added during the oil production process.

One type of produced water, termed blackwater, is characterized as a complex brine water encountered in oilfield production. Blackwater can contain water combined from many different sources, such as drilling and fracturing flowback and has salinity typically higher than observed with seawater. Additionally, blackwater may also contain early and late 3d transition metals coupled to various counter ions of chlorides, sulfates, sulfides, oxides, etc; sludges, carbon-based solids suspended in the water present from guar (gels), friction reducers, and other additives used during oilfield operations; and dissolved organic carbon (DOC) content.

Each of these components can precipitate from the blackwater and foul equipment used in oil well servicing such as surface equipment, downhole equipment, and piping. This fouling reduces heat transfer efficiencies and increases frictional losses through piping. The result is that more energy is required to process the water. If not properly and consistently treated, costs increase, and an expensive acid job turnaround is involved to remove scale. Conventional methods of treating the produced water involves the use of multiple chemicals designed to address differing components of the produced water.

As such, it is presently recognized that, a multifunctional effective treatment composition is desired that can facilitate the purification of produced water.

### SUMMARY

Disclosed herein is a method of purifying a produced water comprising contacting a produced water stream with a composition comprising (i) a chelant; (ii) an oxidizing agent; and (iii) a surfactant under conditions suitable for the formation of a purified produced water.

Also disclosed herein is a composition for purifying produced water comprising (i) a biochelant in an amount of from about 1 wt. % to about 10 wt. %: (ii) an oxidizing agent in an amount of from about 3 wt. % to about 50 wt. %; (iii) a surfactant in an amount of from about 0.1 wt. % to about 70 wt. % wherein the weight percentage is based on the total weight of the composition; and (iv) a solvent.

### BRIEF DESCRIPTION OF DRAWINGS

For a detailed description of the preferred aspects of the disclosed processes and systems, reference will now be made to the accompanying drawings in which:

FIG. 1 is a depiction of biochelants of the type disclosed herein.

FIG. 2 is a plot of well injectivity as a function of time for the samples from Example 1.

### DETAILED DESCRIPTION

Disclosed herein are produced water treatment compositions and methods in which industrial process (e.g., oilfield servicing operations) waters are treated and purified waters generated. Thus, the present disclosure provides methods and compositions for the removal of contaminants from produced waters (e.g., blackwater) and the generation of beneficial end use waters. Herein such compositions for the treatment of produced water are termed produced water treatment compositions and designated PWTC. In an aspect, a PWTC for use in the present disclosure comprises a chelant, an oxidizing agent, a surfactant, and optionally a solvent.

In an aspect, the PWTC comprises a chelant. Herein a chelant, also termed a sequestrant or a chelating agent, refers to a molecule capable of bonding a metal. The chelating agent is a ligand that contains two or more electron-donor groups so that more than one bond is formed between a metal ion and the ligand. In an aspect, the chelant is a biochelant. As used herein, the prefix “bio” indicates that the chemical is produced by a biological process such as through the use of an enzyme catalyst.

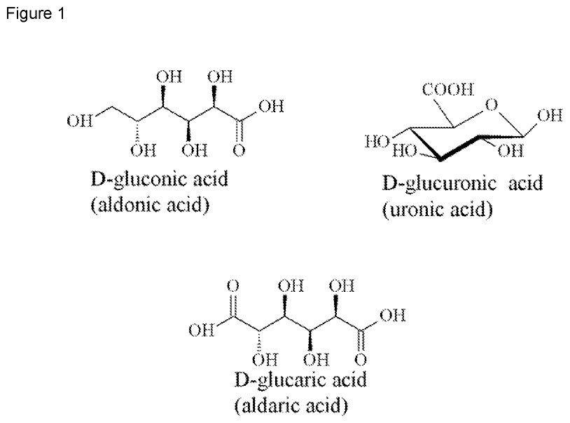

In an aspect, the biochelant comprises an aldonic acid, uronic acid, aldaric acid or combination thereof and a counter cation. Structures of these biochelants are depicted in FIG. 1. The counter cation may comprise an alkali metal (Group I), an alkali earth metal (Group II) or combinations thereof. In certain aspects, the counter cation is sodium, potassium, or calcium.

In an aspect, the biochelant comprises a glucose oxidation product, a gluconic acid oxidation product, a gluconate or combination thereof. The glucose oxidation product, gluconic acid oxidation product or combination thereof may be buffered to a pH in the range of from about 2.6 to about 3.6 using a pH adjusting material in an amount of from about 1 weight percent (wt. %) to about 10 wt. %, alternatively from about 1 wt. % to about 3 wt. %, or alternatively from about 5 wt. % to about 9 wt. % based on the total weight of the biochelant. In an aspect, the biochelant comprises from about 1 wt. % to about 8 wt. % of a caustic solution in a 20 wt. % gluconate solution.

Alternatively, the biochelant comprises a buffered glucose oxidation product, a buffered gluconic acid oxidation product or combinations thereof. In such aspects, the buffered glucose oxidation product, the buffered gluconic acid oxidation product or combinations thereof are buffered to a pH within a range disclosed herein with any suitable acid or base such as sodium hydroxide. In such aspects, the biochelant comprises a mixture of gluconic acid and glucaric acid and further comprises a minor component species comprising n-keto-acids, C2-C5 diacids or combinations thereof.

In an aspect, the biochelant comprises Biochelate™ metal chelation product commercially available from Solugen, Houston Tex.

In an aspect the PWTC is prepared as a concentrate having the biochelant present in an amount of from about 1 wt. % to about 70 wt. %, alternatively from about 20 wt. % to about 70 wt. %, alternatively from about 1 wt. % to about 10 wt. % or alternatively about 10 wt. % to about 50 wt. % based on the total weight of the PWTC.

In an aspect, the PWTC comprises an oxidizing agent. Oxidizing agents suitable for use in the present disclosure may comprise hydrogen peroxide or contain a peroxy bond (—O—O—) and release hydrogen peroxide upon reaction with water. In one or more aspects, the oxidizing agent comprises hydrogen peroxide, dicumyl peroxide, benzoyl peroxide, di-t-butyl peroxide, t-butyl hydroperoxide, a per-carboxylic acid, a peroxy acid, a perester, dialkyl peroxides, 2,5-dimethyl-2,5-di-(t-butylperoxy) hexane, diacyl peroxides, dilauroyl peroxide, dibenzoyl peroxide, peroxyesters, t-butyl peroxy-2-ethylhexanoate, OO-(t-butyl)-O-(2-ethylhexyl) peroxycarbonate, t-butyl peroxy-3,5,5-trimethylhexylhexanoate, t-butyl peroxy benzoate, diperoxyketals, t-amyl peroxides, n-butyl-4,4-di-(t-butyl peroxy) valerate, di-t-butyl peroxide, 2,5-dimethyl-2,5-di-(t-butylperoxy) hexane (DHBP), diacyl peroxides, dilauroyl peroxide, dibenzoyl peroxide, peroxyesters, t-butyl peroxy-2-ethyl hexanoate, OO-(t-butyl)-O-(2-ethylhexyl) peroxycarbonate, t-butyl peroxy-3,5,5-trimethylhexylhexanoate, t-butyl peroxy benzoate, diperoxyketals, diacyl peroxides, t-amyl peroxides, n-butyl-4,4-di-(t-butyl peroxy) valerate, and the like, or combinations thereof. In an aspect the oxidizing agent comprises hydrogen peroxide.

Alternatively, the oxidizing agent comprises a salt having X waters of crystallization wherein X is equal to or greater than 1 and wherein at least one of the waters of crystallization has been replaced with hydrogen peroxide. Such salts may be represented by the general formula Y.nH₂O.mH₂O₂ wherein Y is a salt, n is equal to or greater than zero and m is equal to or greater than 1. Examples of oxidizing agents which contain a peroxy bond and release hydrogen peroxide only upon reaction with water include without limitation perphoshate [(P₂O₈)⁴⁻], persulfate [(S₂O₈)²⁻], and perborate [(BO₃)⁻] salts of alkali metals, alkaline earth metals and ammonium ion.

The oxidizing agent may be present in the PWTC concentrate in an amount of from about 3 wt. % to about 50 wt. %. alternatively from about 20 wt. % to about 34 wt. %, alternatively from about 34 wt. % to about 50 wt. % or alternatively from about 3 wt. % to about 8 wt. % based on the total weight of the PWTC. It is contemplated that factors such as stability, and concentrations of species that needs to be oxidized will influence the weight percentage of any component of the PWTC utilized.

In an aspect, the PWTC comprises a surfactant. Surfactants are compounds that display a dual nature, with affinity to both brine and hydrocarbon phases. In the presence of brine and oil, surfactants will position at the interface to form a molecular bridge between the brine and hydrocarbons, which then lowers the interfacial tension to near zero values (<10⁻³ mN/m). This is equivalent to saying the phases behave as almost fully miscible.

Nonlimiting examples of surfactants suitable for use in the PWTC include ethoxylated nonyl phenol phosphate esters, nonionic surfactants, cationic surfactants, anionic surfactants, amphoteric/zwitterionic surfactants, alkyl glucoside, quaternary amine, alkyl phosphonium chloride, alkyl phosphonate surfactants, linear alcohols, nonylphenol compounds, alkyoxylated fatty acids, alkylphenol alkoxylates, ethoxylated amides, betaines, methyl ester sulfonates, hydrolyzed keratin, sulfosuccinates, taurates, amine oxides, alkoxylated alcohols, lauryl alcohol ethoxylate, ethoxylated nonyl phenol, ethoxylated fatty amines, ethoxylated alkyl amines, cocoalkylamine ethoxylate, modified betaines, alkylamidobetaines, cocoamidopropyl betaine, quaternary ammonium compounds, trimethyltallowammonium chloride, trimethylcocoammonium chloride, or combinations thereof.

The surfactant may be present in the PWTC concentrate in an amount of from about 0.1 wt. % to about 70 wt. %, alternatively from about 0.1 wt. % to about 10 wt. %, alternatively from about 4 wt. % to about 8 wt. % or alternatively from about 50 wt. % to about 70 wt. % based on the total weight of the PWTC.

In an aspect, the PWTC optionally comprises a solvent. In some aspects the solvent comprises C₂ to C₂₀ ethers, C₂ to C₂₀ carbonates, C₂ to C₂₀ esters, C₂ to C₂₀ ketones, C₂ to C₂₀ aldehydes, C₂ to C₂₀ alcohols or combinations thereof. Alternatively, the solvent comprises a C₂ to C₂₀ alcohol. Nonlimiting examples of alcohols suitable for use in the present disclosure include methanol, ethanol, propanol, butanol, pentanol; isopropanol, ethylene glycol and propylene glycol. Alternatively the solvent comprises water.

Solvent may be present in the PWTC in an amount sufficient to provide a composition having suitable rheological properties to meet some user or process goal.

In one or more aspects, a PWTC of the present disclosure acts by oxidizing organic materials (e.g., DOC) such that these materials can reach the complete mineralization of pollutants or at least their transformation into more biodegradable products. Oxidation as pre-treatment may increase the biodegradability of the produced water (e.g., blackwater).

In an aspect, an oxidizing agent of the type disclosed herein is contacted with the produced water prior to treatment with the PTWC. In such aspects, the oxidizing agent (e.g., H₂O₂) may be in an amount that is about 50% less than the amount of oxidizing agent present in the PWTC, alternatively about 60%, 70%, 80% or 90% less than the amount of oxidizing agent present in the PWTC.

In one or more aspects, a PWTC may also function to sequester metals (e.g., iron) and reduce or prevent the formation of iron sulfide species. As known to one of ordinary skill in the art, a range of iron sulfides, of varying stoichiometry and crystalline forms, may cause operational problems in many well-servicing situations. Iron sulfide precipitation in the formation matrix, tubulars and associated equipment may result in losses in production, reduced injectivity and inhibit well intervention by wireline. Iron sulfide films on steel surfaces may cause under-deposit corrosion and promote hydrogen damage. Also, because iron sulfide particulates stabilize oil/water emulsions, and therefore impede separation, they may initiate environmental problems by causing oily water emissions.

In one or more aspects, a PWTC may also function to facilitate the separation of oil from the produced water. In such aspects, the PWTX may function as a demulsifier. Demulsifying is a complex application within the oilfield chemical industry, facilitating the economical removal of water from crude oil and the clarification of produced water before discharge.

A PWTC of the present disclosure may provide oxidation, chelating, and/or demulsifying functions in a single composition. In an aspect, a PWTC concentrate of the type disclosed herein may be diluted to provide a solution having PWTC amounts ranging from about 0.001 wt. % to about 10 wt. %, alternatively from about 0.001 wt. % to about 0.1 wt. %, alternatively from about 1 wt. % to about 10 wt. % or alternatively from about 0.01 wt. % to about 0.05 wt. % using any suitable solvent to give a final formulation for use in the purification of produced water.

In an aspect, a PWTC of the disclosure may be used to treat produced water (e.g., blackwater) from a production well of an oil and/or gas field using any suitable methodology. In an aspect, a method for utilizing a PWTC of the type disclosed herein comprises obtaining a first stream by introducing a produced water stream to a suitable container (e.g., a mixer, a blender). The container can be any container that is compatible with the materials disclosed herein and has sufficient space for said materials.

For example, a method of the present disclosure comprises flowing produced water (e.g., blackwater) from a wellhead to production and/or sales tanks. In one or more aspects a PWTC, of the type disclosed herein, is contacted with the produced water by any suitable methodology such as through a batch process wherein the PWTC is introduced to the production/sales tanks. In a continuous process the PWTC may be contacted with the produced water by injecting the PWTC into the conduit flowing the produced water into the container. Contact of the PWTC with the produced water can allow for various portions of the produced water to be more easily separated. For example, any emulsions can be at least partially broken to allow the hydrocarbons to be separated from the produced water, thereby producing a purified produced water. In an aspect, contact of the PWTC with the produced water results in a purified produced water characterized by a reduced content of DOC, a reduced oil content, and/or a reduced the level of free multivalent cations (e.g., ^{Fe2+}) when compared to the produced water prior to treatment.

In an aspect, purified produced water prepared as described herein has a DOC content that is reduced to from about 1 mg/l to about 10,000 mg/l, alternatively from about 1,000 mg/l to about 10,000 mg/l, alternatively from about 100 mg/l to about 1,000 mg/l or alternatively from about 1 mg/l to about 100 mg/l; a content of free multivalent cation that is reduced by from about 1 mg/l to about 10,000 mg/l alternatively from about 1,000 mg/l to about 10,000 mg/l, alternatively from about 100 mg/l to about 1,000 mg/l or alternatively from about 1 mg/l to about 100 mg/l and an oil content that is reduced by from about 1 mg/l to about 10,000 mg/l, alternatively from about 1,000 mg/l to about 10,000 mg/l, alternatively from about 1,000 mg/l to about 100 mg/l or alternatively from about 1 mg/l to about 100 mg/l when compared to the produced water.

In an aspect, the purified produced water, may be conveyed (e.g., pipelined or trucked) to produced water tanks (e.g., sweet produced water tanks).

In an aspect, a method is provided to introduce a PWTC into a total injection and production system to reduce well injection pressure, increase injection rate, and/or increase hydrocarbon production. For example, a PWTC of the type disclosed herein may be combined with a produced water (e.g., blackwater) and the purified produced water injected into an injection well.

In an aspect, the compositions and method of the present disclosure may result in a reduction of injection pressure ranging from about 10% to about 75%, alternatively from about 10% to about 50% or alternatively from about 10% to 25% with a concomitant increase in injection rate and/or production rate of from about 10% to about 75%, alternatively from about 10% to about 50% or alternatively from about 10% to 25%.

### EXAMPLES

The subject matter having been generally described, the following examples are given as particular aspects of the disclosure and are included to demonstrate the practice and advantages thereof, as well as aspects and features of the presently disclosed subject matter. It should be appreciated by those of skill in the art that the techniques disclosed in the examples which follow represent techniques discovered by the inventors to function well in the practice of the present subject matter, and thus can be considered to constitute preferred modes for its practice. However, those of skill in the art should, in light of the present disclosure, appreciate that many changes can be made in the specific aspects which are disclosed and still obtain a like or similar result without departing from the scope of the inventions of the instant disclosure. It is understood that the examples are given by way of illustration and are not intended to limit the specification of the claims to follow in any manner.

### Example 1

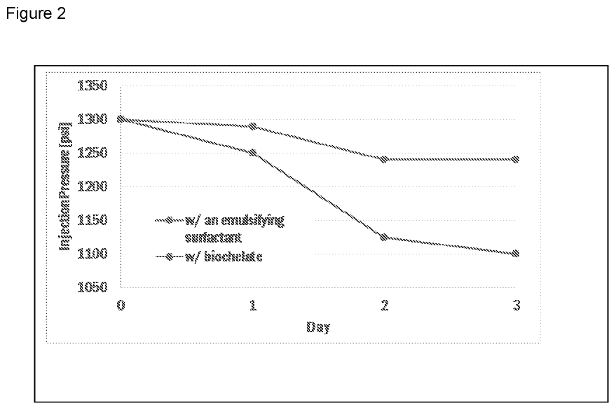

A salt water disposal well was treated with an oxidizer-biochelant blend and an oxidizer-emulsifier blend, all of the type disclosed herein. The treatment using the oxidizer-emulsifier blend proceeded first. Then, the well was flushed for 4 days at approximately 6,500 barrels per day (bbl/day) for a total of 26,000 bbl. After the well was thoroughly flushed, a treatment with an oxidizer-biochelant was performed. FIG. 2 is a graph illustrating injection pressure (psi) as a function of time (days) for an oxidizer-emulsifier combination and an oxidizer-biochelant combination. After the treatment was completed, a total injection pressure reduction of 200 psi was observed. When compared to the oxidizer-emulsifier formulation, an improvement of 140 psi was observed. The composition of the field trial is indicated in Table 1.

TABLE 1

| | Hydrogen | | |
|---|---|---|---|
| | Peroxide % | Emulsifier % | Biochelant % |
| Mixture | wt | wt | wt |
| Oxidizer - Emulsifier | 33.0 | 2.6 | 0.0 |
| Oxidizer - Biochelant | 30.6 | 0.0 | 8.0 |

### Example 2

A solution of produced water from a sour well was sampled and dosed at 500 ppm (0.5 gpt). The additives that were used were 50% active biochelant/glutaraldehyde, 50% active biochelant, 75% active tetrakis (hydroxymethyl)phosphonium Sulfate (THPS), and 30% active biochelant/glutaraldehyde. The bottles were placed in a shaker at room temperature for 24 hours. The formulations of the additives are indicated in Table 2. After 24 hours, the solution was filtered. The biochelant performed more effectively by having fewer solids present in the solution after treatment than the incumbent 75% THPS solution. The results are indicated in Table 3.

TABLE 2

| | Biochelant % | Glutaraldehyde % | THPS % |
|---|---|---|---|
| Mixture | wt | wt | wt |
| Biochelant | 54.0 | 4.3 | 0.0 |
| Glutaraldehyde/ | | | |
| Biochelant | 50.0 | 0.0 | 0.0 |
| Biochelant | 19.6 | 1.5 | 0.0 |
| Glutaraldehyde/ | | | |
| 75% THPS | 0.0 | 0.0 | 75.0 |

TABLE 3

| | | Treatment | Solids After |
|---|---|---|---|
| Additive | % Active | Dosage | Treatment |
| Biochelant/ | 54 | 500 ppm (0.50 gptg) | 0.3 grams |
| Glutaraldehyde | | | |
| Biochelant | 50 | 500 ppm (0.50 gptg) | 0.3 grams |
| Biochelant/ | 20 | 500 ppm (0.50 gptg) | 0.5 grams |
| Glutaraldehyde | | | |
| 75% THPS | 75 | 500 ppm (0.50 gptg) | 0.5 grams |

### Example 3

The ability of a biochelant of the type disclosed herein to facilitate iron chelation was investigated. As a comparative, stability constants for the indicated chelant and metal combinations are presented in Table 4.

TABLE 4

| | Citrate | | EDTA | | Gluco- | Gluconate |
|---|---|---|---|---|---|---|
| | [MHL]/ | [ML]/ | [MHL]/ | [ML]/ | hepatonate | [ML]/ |
| Metal | [M][H][L] | [M][L] | [M][H][L] | [M][L] | [ML]/[M][L] | [M][L] |
| Al⁺³ | 11.8 | 8.1 | 20.7 | 18.0 | — | — |
| Ca⁺² | 7.6 | 3.4 | 15.0 | 11.6 | 1.25 | 2.2 |
| Cu⁺² | 9.5 | 6.7 | 22.9 | 19.7 | 41.2 | 38.9 |
| Fe⁺² | 8.7 | 4.5 | 18.2 | 15.3 | 1.1 | 1 |
| Fe⁺³ | 12.4 | 11.2 | 28.0 | 26.5 | 38.3 | 37.2 |
| Mg⁺² | 7.2 | 3.2 | 19.9 | 9.8 | 0.78 | 0.7 |
| Mn⁺² | 7.1 | 3.7 | 18.2 | 14.8 | — | — |
| Zn⁺² | 8.7 | 5.0 | 10.7 | 17.5 | 1.82 | 1.7 |

Sample 1 was prepared by adding 5 ml of a 0.1M FeCl₂ solution to a beaker to which was added 10 mL of deionized water to form a solution. A biochelant of the type disclosed herein (2 ml) was then added to the solution followed by 1 mL of a 34% hydrogen peroxide. The pH of the solution was adjusted with the addition of 1 mL of NaOH. The sample changed color from green to yellow indicating the effective oxidation of Fe²⁺ to Fe³⁺ by a PWTC of the type disclosed herein. A second sample, Sample 2, was prepared by the addition of 5 mL of a 0.1M FeCl₂ solution to a beaker to which was added 10 mL of deionized water. The pH of the solution was adjusted with the addition of 1 mL of NaOH. The resulting mixture had a green color indicating the iron stayed in its ferrous (Fe⁺²) state. A third sample, Sample 3, was prepared by adding 5 ml of a 0.1M FeCl₂ solution to a beaker to which was added 10 mL of deionized water. An oxidant, 34% H₂O₂ (1 mL), was then added and the solution pH adjusted with the addition of 1 mL of NaOH. The solution had a rust color and precipitants, this indicated the iron was oxidized from Fe²⁺ to Fe³⁺.

The effect of peroxide concentration on ion binding was investigated. Specifically, a fourth sample, Sample 4, was prepared by adding 5 ml of a 0.1M FeCl₂ solution to a beaker to which was added 10 mL of deionized water. To this solution was added 0.52 ml of 7.5 wt. % H₂O₂ and 23 wt. % of a biochelant of the type disclosed herein. The pH of the mixture was adjusted with the addition of 1 mL of NaOH. Sample 4 developed a clear rust color indicating that most but not all of the iron was oxidized and chelated. Notably, the clarity of the solution indicates that there were not any precipitants in the solution. A fifth sample, Sample 5, was prepared by adding 5 ml of a 0.1M FeCl₂ solution to a beaker to which was added 10 mL of deionized water. To this solution was added 0.27 ml of a 3 wt. % H₂O₂ solution and a sufficient amount of a sodium gluconate/gluconic acid blend to give a final amount of 45 wt. %. The pH of the mixture was adjusted with the addition of 1 mL of NaOH. Sample 5 developed a dark green color indicating that most of the iron was not oxidized and remained as Fe²⁺.

These experiments demonstrate that addition of peroxide after introduction of the biochelant or concomitant with the introduction of the biochelant can effectively oxidize ferrous iron to ferric.

The chelating ability of a biochelant of the type disclosed herein was investigated by ion-coupled plasma optical emission spectroscopy (ICP-OES). Solutions containing 30 mg/L Fe(III) was prepared by dissolving Fe(III)Cl₃ in deionized water. Hydrolysis of iron chloride caused the pH of the solution to reach ˜2.5. Solutions were allowed to sit overnight at room temperature for 24 hours and were adjusted to a pH of 5 using 1N NaOH. Each sample was filtered through 0.43 um filter prior to analysis by ICP-OES. The results are presented in Table 5.

TABLE 5

| | | | | Fe | | % Fe |
|---|---|---|---|---|---|---|
| | | Dosage | Fe mg/L | mg/L @ | Final | remaining |
| Product | % Active | [ppm] | start | final pH | pH | in solution |
| Blank | 0% | 0 | 30 | 10.26 | 4 | 34% |
| PWTC 1 | 30% | 120 | 30 | 26.07 | 4 | 87% |
| PWTC 2 | 60% | 120 | 30 | 31.67 | 4 | 100% |
| 75% THPS | 75% | 120 | 30 | 0.12 | 4 | 0% |
| 40% EDTA | 40% | 120 | 30 | 18.71 | 4 | 62% |
| 50% THPS | 50% | 120 | 30 | 0.36 | 4 | 1% |
| Blank | 0% | 0 | 30 | 0 | 6 | 0% |
| PWTC 1 | 30% | 120 | 30 | 30.1 | 6 | 100% |
| PWTC 2 | 60% | 120 | 30 | 36.59 | 6 | 100% |
| 75% THPS | 75% | 120 | 30 | 0 | 6 | 0% |
| 40% EDTA | 40% | 120 | 30 | 8.86 | 6 | 30% |
| 50% THPS | 50% | 120 | 30 | 0 | 6 | 0% |
| Blank | 0% | 0 | 30 | 0 | 8 | 0% |
| PWTC 1 | 30% | 120 | 30 | 25.74 | 8 | 86% |
| PWTC 2 | 60% | 120 | 30 | 32.56 | 8 | 100% |
| 75% THPS | 75% | 120 | 30 | 0 | 8 | 0% |
| 40% EDTA | 40% | 120 | 30 | 8.58 | 8 | 29% |
| 50% THPS | 50% | 120 | 30 | 0 | 8 | 0% |

The results demonstrate the effectiveness of the PWTCs of the present disclosure in the chelation of iron species.

### Example 4

The oxidation-reduction potential (ORP) of compositions of the type disclosed herein were investigated. Specifically, a first sample, designated C1, was prepared using the indicated amount of a 34 wt. % H₂O₂ solution. A second sample, designated, Sample 6, contained a PWTC and the indicated amount of a 34 wt. % H₂O₂ solution. The initial pH of the samples was recorded and the ORP measured.

The pH of the sample was adjusted with NaOH to the desired pH. Subsequently, the ORP reading, final pH, as well as the amount of NaOH added was recorded. The results are presented in Table 6.

TABLE 6

| | | | | | ORP (mV) | | ORP (mV) |
|---|---|---|---|---|---|---|---|
| | Dosage | | ORP | pH | after pH | pH | after pH |
| | (ppm) | pH | (mV) | adjusted | adjustment | adjusted | adjustment |
| Sample 6 | 50 | 6.00 | 370 | 6.5 | 358 | 7.5 | 358 |
| | 100 | 5.71 | 376 | 6.5 | 362 | 7.5 | 345 |
| | 200 | 5.14 | 403 | 6.5 | 380 | 7.5 | 333 |
| | 300 | 5.11 | 408 | 6.5 | 392 | 7.5 | 329 |
| C1 | 50 | 6.37 | 356 | 6.5 | 351 | 7.5 | 300 |
| | 100 | 6.66 | 352 | 6.5 | 342 | 7.5 | 315 |
| | 200 | 6.67 | 348 | 6.5 | 310 | 7.5 | 300 |
| | 300 | 6.48 | 351 | 6.5 | 320 | 7.5 | 302 |

The ORP measurements for the control samples, C1, were slightly higher with the samples containing a PWTC, Sample 6.

The effect of chloride on the ORP of compositions of the type disclosed herein was investigated. Specifically, samples were prepared using deionized water, 34% hydrogen peroxide, 8 wt. % sodium gluconate, 4 wt. % or 8 wt. % sodium chloride and 5 wt. % NaOH for pH adjustment.

Samples, designated Sample 7-9, were prepared by adding peroxide, DI water and sodium gluconate to a 250 ml flask to give the final amounts indicated in Table 7. The initial pH and ORP of the sample were recorded. The pH of the sample was adjusted with either HCl or NaOH and the final pH and ORP recorded. The results are presented in Table 8.

TABLE 7

| Sample 7 | % by wt. | Sample 8 | % by wt. | Sample 9 | % by wt. |
|---|---|---|---|---|---|
| Hydrogen Peroxide | 67.65 | Hydrogen Peroxide | 67.65 | Hydrogen Peroxide | 67.65 |
| DI Water | 24.35 | DI Water | 28.35 | DI Water | 24.35 |
| Sodium Gluconate | 8 | Sodium Chloride | 4 | Sodium Chloride | 8 |

TABLE 8

| | Initial | Initial | pH | ORP | pH | ORP |
|---|---|---|---|---|---|---|
| Experiment | pH | ORP (mV) | adjusted | (mV) | adjusted | (mV) |
| Sample 7 | 5.52 | 408 | 6.49 | 317 | 7.51 | 214.2 |
| Sample 8 | 2.77 | 420 | 6.5 | 284 | 7.5 | 195 |
| Sample 9 | 2.73 | 426 | 6.51 | 282.1 | 7.5 | 190 |

The ORP measurements were slightly higher with Sample 7 (hydrogen peroxide with sodium gluconate) as compared to Sample 8 (hydrogen peroxide with 4% sodium chloride) and Sample 9 (hydrogen peroxide with 8% sodium chloride).

### ADDITIONAL DISCLOSURE

The following are non-limiting, specific aspects in accordance with the present disclosure:

A first aspect which is a method of purifying a produced water comprising contacting a produced water stream with a composition comprising (i) a chelant; (ii) an oxidizing agent; and (iii) a surfactant under conditions suitable for the formation of a purified produced water.

A second aspect which is the method of the first aspect wherein the chelant comprises a biochelant.

A third aspect which is the method of any of the first through second aspects wherein the biochelant comprises an aldonic acid, uronic acid, aldaric acid or combinations thereof.

A fourth aspect which is the method of any of the second through third aspects wherein the biochelant further comprises a counter cation.

A fifth aspect which is method of the fourth aspect wherein the counter cation comprises an alkali metal, an alkali earth metal or combinations thereof.

A sixth aspect which is the method of any of the fourth through fifth aspects wherein the counter cation comprises sodium, potassium, or calcium.

A seventh aspect which is the method of any of the second through sixth aspects wherein the biochelant comprises a buffered glucose oxidation product, a buffered gluconic acid oxidation product or combinations thereof.

An eighth aspect which is the method of the seventh aspect wherein the buffered glucose oxidation product, the buffered gluconic acid oxidation product or combinations thereof is buffered to a pH of from about 2.6 to about 3.6.

A ninth aspect which is the method of any of the seventh through eighth aspects wherein the buffered glucose oxidation product, the buffered gluconic acid oxidation product or combinations thereof further comprises n-keto-acids, C2-C5 diacids or combinations thereof.

A tenth aspect which is the method of any of the first through ninth aspects wherein the chelant is present in the composition in the amount of from about 1 wt. % to about 10 wt. % based on the total weight of the composition.

An eleventh aspect which is the method of any of the first through tenth aspects wherein the oxidizing agent comprises hydrogen peroxide, dicumyl peroxide, benzoyl peroxide, di-t-butyl peroxide, t-butyl hydroperoxide, a per-carboxylic acid, a peroxy acid, a perester, dialkyl peroxides, 2,5-dimethyl-2,5-di-(t-butylperoxy) hexane, diacyl peroxides, dilauroyl peroxide, dibenzoyl peroxide, peroxyesters, t-butyl peroxy-2-ethylhexanoate, OO-(t-butyl)-O-(2-ethylhexyl) peroxycarbonate, t-butyl peroxy-3,5,5-trimethylhexylhexanoate, t-butyl peroxy benzoate, diperoxyketals, t-amyl peroxides, n-butyl-4,4-di-(t-butyl peroxy) valerate, di-t-butyl peroxide, 2,5-dimethyl-2,5-di-(t-butylperoxy) hexane (DHBP), diacyl peroxides, dilauroyl peroxide, dibenzoyl peroxide, peroxyesters, t-butyl peroxy-2-ethylhexanoate, OO-(t-butyl)-O-(2-ethylhexyl) peroxycarbonate, t-butyl peroxy-3,5,5-trimethylhexylhexanoate, t-butyl peroxy benzoate, diperoxyketals, diacyl peroxides, t-amyl peroxides, n-butyl-4,4-di-(t-butyl peroxy) valerate, or combinations thereof.

A twelfth aspect which is the method of any of the first through eleventh aspects wherein the oxidizing agent comprises hydrogen peroxide.

A thirteenth aspect which is the method of any of the first through twelfth aspects wherein the oxidizing agent is characterized by the general formula Y.nH₂O.mH₂O₂ wherein Y is a salt; n is equal to or greater than zero; and m is equal to or greater than 1.

A fourteenth aspect which is the method of any of the first through thirteenth aspects wherein the oxidizing agent is present in the composition in an amount of from about 3 wt. % to about 50 wt. % based on the total weight of the composition.

A fifteenth aspect which is the method of any of the first through fourteenth aspects wherein the surfactant comprises ethoxylated nonyl phenol phosphate esters, nonionic surfactants, cationic surfactants, anionic surfactants, amphoteric/zwitterionic surfactants, alkyl glucoside, quaternary amine, alkyl phosphonium chloride, alkyl phosphonate surfactants, linear alcohols, nonylphenol compounds, alkyoxylated fatty acids, alkylphenol alkoxylates, ethoxylated amides, betaines, methyl ester sulfonates, hydrolyzed keratin, sulfosuccinates, taurates, amine oxides, alkoxylated alcohols, lauryl alcohol ethoxylate, ethoxylated nonyl phenol, ethoxylated fatty amines, ethoxylated alkyl amines, cocoalkylamine ethoxylate, modified betaines, alkylamidobetaines, cocoamidopropyl betaine, quaternary ammonium compounds, trimethyltallowammonium chloride, trimethylcocoammonium chloride, or combinations thereof.

A sixteenth aspect which is the method of any of the first through fifteenth aspects wherein the surfactant is present in an amount of from about 0.1 wt. % to about 70 wt. % based on the total weight of the composition.

A seventeenth aspect which is the method of any of the first through sixteenth aspects wherein the composition further comprises a solvent.

An eighteenth aspect which is the method of the seventeenth aspect wherein the solvent comprises C₂ to C₂₀ ethers, C₂ to C₂₀ carbonates, C₂ to C₂₀ esters, O₂ to C₂₀ ketones, C₂ to C₂₀ aldehydes, C₂ to C₂₀ alcohols or combinations thereof.

A nineteenth aspect which is the method of any of the seventeenth and eighteenth aspects wherein the solvent comprises a C₂ to C₂₀ alcohol.

A twentieth aspect which is the method of any of the seventeenth through nineteenth aspects wherein the solvent comprises methanol, ethanol, propanol, butanol, pentanol, isopropanol, ethylene glycol, propylene glycol or a combination thereof.

A twenty-first aspect which is the method of any of the seventeenth through twentieth aspects wherein the solvent comprises water.

A twenty-second aspect which is the method of any of the first through twenty-first aspects wherein the purified produced water has a dissolved organic carbon content that is reduced by from about 1 mg/l to about 10,000 mg/l.

A twenty-third aspect which is the method of any of the first through twenty-second aspects wherein the purified produced water has a multivalent ion content that is reduced by from about 1 mg/l to about 10,000 mg/l.

A twenty-fourth aspect which is the method of any of the first through twenty-third aspects wherein the purified produced water has an oil content that is reduced by from about 1 mg/l to about 10,000 mg/l.

A twenty-fifth aspect which is a composition for purifying produced water comprising (i) a biochelant in an amount of from about 1 wt. % to about 10 wt. %: (ii) an oxidizing agent in an amount of from about 3 wt. % to about 50 wt. %; (iii) a surfactant in an amount of from about 0.1 wt. % to about 70 wt. % wherein the weight percentage is based on the total weight of the composition; and (iv) a solvent.

While aspects of the disclosure have been shown and described, modifications thereof can be made without departing from the spirit and teachings of the presently disclosed subject matter. The aspects and examples described herein are exemplary only, and are not intended to be limiting. Many variations and modifications of the subject matter disclosed herein are possible and are within the scope of the present disclosure.

At least one aspect is disclosed and variations, combinations, and/or modifications of the aspect(s) and/or features of the aspect(s) made by a person having ordinary skill in the art are within the scope of the disclosure. Alternative aspects that result from combining, integrating, and/or omitting features of the aspect(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, 5, 6, . . . greater than 0.10 includes 0.11, 0.12, 0.13, 0.14, 0.15, . . . ). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k* (Rᵤ—Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the detailed description of the presently disclosed subject matter.

1. A method of purifying a produced water comprising:
contacting a produced water stream with a composition comprising a (i) a chelant; (ii) an oxidizing agent; and (iii) a surfactant under conditions suitable for the formation of a purified produced water.

2. The method of claim 1 wherein the chelant comprises a biochelant.

3. The method of claim 2 wherein the biochelant comprises an aldonic acid, uronic acid, aldaric acid or combinations thereof.

4. The method of claim 2 wherein the biochelant further comprises a counter cation.

5. The method of claim 4 wherein the counter cation comprises an alkali metal, an alkali earth metal or combinations thereof.

6. The method of claim 4 wherein the counter cation comprises sodium, potassium, or calcium.

7. The method of claim 2 wherein the biochelant comprises a buffered glucose oxidation product, a buffered gluconic acid oxidation product or combinations thereof.

8. The method of claim 7 wherein the buffered glucose oxidation product, the buffered gluconic acid oxidation product or combinations thereof is buffered to a pH of from about 2.6 to about 3.6.

9. The method of claim 7 wherein the buffered glucose oxidation product, the buffered gluconic acid oxidation product or combinations thereof further comprises n-keto-acids, C2-C5 diacids or combinations thereof.

10. The method of claim 1 wherein the chelant is present in the composition in the amount of from about 1 wt. % to about 10 wt. % based on the total weight of the composition.

11. The method of claim 1 wherein the oxidizing agent comprises hydrogen peroxide, dicumyl peroxide, benzoyl peroxide, di-t-butyl peroxide, t-butyl hydroperoxide, a per-carboxylic acid, a peroxy acid, a perester, dialkyl peroxides, 2,5-dimethyl-2,5-di-(t-butylperoxy) hexane, diacyl peroxides, dilauroyl peroxide, dibenzoyl peroxide, peroxyesters, t-butyl peroxy-2-ethylhexanoate, OO-(t-butyl)-O-(2-ethylhexyl) peroxycarbonate, t-butyl peroxy-3,5,5-trimethylhexylhexanoate, t-butyl peroxy benzoate, diperoxyketals, t-amyl peroxides, n-butyl-4,4-di-(t-butyl peroxy) valerate, di-t-butyl peroxide, 2,5-dimethyl-2,5-di-(t-butylperoxy) hexane (DHBP), diacyl peroxides, dilauroyl peroxide, dibenzoyl peroxide, peroxyesters, t-butyl peroxy-2-ethyl hexanoate, OO-(t-butyl)-O-(2-ethylhexyl) peroxycarbonate, t-butyl peroxy-3,5,5-trimethylhexylhexanoate, t-butyl peroxy benzoate, diperoxyketals, diacyl peroxides, t-amyl peroxides, n-butyl-4,4-di-(t-butyl peroxy) valerate, or combinations thereof.

12. The method of claim 1 wherein the oxidizing agent comprises hydrogen peroxide.

13. The method of claim 1 wherein the oxidizing agent is characterized by the general formula Y.nH₂O.mH₂O₂
wherein Y is a salt;
n is equal to or greater than zero; and
m is equal to or greater than 1.

14. The method of claim 1 wherein the oxidizing agent is present in the composition in an amount of from about 3 wt. % to about 50 wt. % based on the total weight of the composition.

15. The method of claim 1 wherein the surfactant comprises ethoxylated nonyl phenol phosphate esters, nonionic surfactants, cationic surfactants, anionic surfactants, amphoteric/zwitterionic surfactants, alkyl glucoside, quaternary amine, alkyl phosphonium chloride, alkyl phosphonate surfactants, linear alcohols, nonylphenol compounds, alkyoxylated fatty acids, alkylphenol alkoxylates, ethoxylated amides, betaines, methyl ester sulfonates, hydrolyzed keratin, sulfosuccinates, taurates, amine oxides, alkoxylated alcohols, lauryl alcohol ethoxylate, ethoxylated nonyl phenol, ethoxylated fatty amines, ethoxylated alkyl amines, cocoalkylamine ethoxylate, modified betaines, alkylamidobetaines, cocoamidopropyl betaine, quaternary ammonium compounds, trimethyltallowammonium chloride, trimethylcocoammonium chloride, or combinations thereof.

16. The method of claim 1 wherein the surfactant is present in an amount of from about 0.1 wt. % to about 70 wt. % based on the total weight of the composition.

17. The method of claim 1 wherein the composition further comprises a solvent.

18. The method of claim 17 wherein the solvent comprises C₂ to C₂₀ ethers, C₂ to C₂₀ carbonates, C₂ to C₂₀ esters, C₂ to C₂₀ ketones, C₂ to C₂₀ aldehydes, C₂ to C₂₀ alcohols or combinations thereof.

19. The method of claim 17 wherein the solvent comprises a C₂ to C₂₀ alcohol.

20. The method of claim 17 wherein the solvent comprises methanol, ethanol, propanol, butanol, pentanol, isopropanol, ethylene glycol, propylene glycol or a combination thereof.

21. The method of claim 17 wherein the solvent comprises water.

22. The method of claim 1 wherein the purified produced water has a dissolved organic carbon content that is reduced by from about 1 mg/l to about 10,000 mg/l when compared to a dissolved organic carbon content of the produced water.

23. The method of claim 1 wherein the purified produced water has a multivalent ion content that is reduced by from about 1 mg/l to about 10,000 mg/l when compared to a multivalent ion content of the produced water.

24. The method of claim 1 wherein the purified produced water has an oil content that is reduced by from about 1 mg/l to about 10,000 mg/l when compared to an oil content of the produced water.

25. A composition for purifying produced water comprising:
(i) a biochelant in an amount of from about 1 wt. % to about 10 wt. %;
(ii) an oxidizing agent in an amount of from about 3 wt. % to about 50 wt. %;
(iii) a surfactant in an amount of from about 0.1 wt. % to about 70 wt. % wherein the weight percentage is based on the total weight of the composition; and
(iv) a solvent.
